(19) United States
(12) Patent Application Publication
(10) Pub. No.: US 2017/0025771 A1
(43) Pub. Date: Jan. 26, 2017

(54) TERMINAL BLOCK

(71) Applicant: WEIDMÜLLER INTERFACE GMBH & CO. KG, Detmold (DE)

(72) Inventors: Martin ADAMCZYK, Detmold (DE); Jörn BUHRKE, Bünde (DE); Genadij NEUMANN, Detmold (DE); Andreas RUTZ, Bielefeld (DE)

(21) Appl. No.: 15/119,221

(22) PCT Filed: Mar. 25, 2015
(86) PCT No.: PCT/EP2015/056323

§ 371 Date: Aug. 16, 2016

(30) Foreign Application Priority Data
Apr. 14, 2014 (DE) 10 2014105316.8

(51) Int. Cl. H01R 9/26; H01R 11/07

(52) U.S. Cl. CPC H01R 9/2675; H01R 9/2691; H01R 11/07

(57) ABSTRACT

A terminal block assembly is provided, comprising a plurality of terminal blocks mounted on a common horizontal support member, including a supply terminal block connected with a voltage source, and a plurality of distribution terminal blocks connected with a plurality of loads, respectively, characterized in that the length and height dimensions of the terminal blocks are the same, but the width of the supply terminal block is greater than that of the distribution terminal blocks, and that the supply conductor contact arrangements of the supply terminal block are designed for connection with a supply conductor having a relatively large cross-sectional area, while the distribution conductor contact arrangements of the distribution terminal blocks are designed for connection with distribution conductors having a relatively small cross-sectional area. A conductive comb member extends transversely across the assembly to interconnect the electrical circuitry contained within the terminal block housings.

### REFERENCE TO RELATED APPLICATIONS

This application is a national stage application under 35 U.S.C. §371 of the PCT International Application No. PCT/EP2015/056323 filed Mar. 25, 2015, which claims priority of the German application No. DE 10 2014 105 316.8 filed Apr. 14, 2014.

### BACKGROUND OF THE INVENTION

Field of the Invention

An assembly of a plurality of terminal blocks mounted on a common horizontal support member is provided, including a supply terminal block connected with a voltage source, and a plurality of distribution terminal blocks connected with a plurality of loads, respectively, characterized in that the length and height dimensions of the terminal blocks are the same, but the width of the supply terminal block is greater than that of the distribution terminal blocks, and that the supply conductor contact arrangements of the supply terminal block are designed for connection with a supply conductor having a relatively large cross-sectional area, while the distribution conductor contact arrangements of the distribution terminal blocks are designed for connection with distribution conductors having a relatively small cross-sectional area.

Description of Related Art

Modular terminal blocks have long been known in the most diverse of configurations. They are assembled on the mounting base, generally a hat-shaped support rail, into functional blocks, such as a functional block for the power supply of consumers. For this, according to the prior art, several output terminals are placed in a row on a modular terminal block, serving as a feed-in terminal, wherein the potential distribution within the terminal block occurs by means of bus bars or by means of so-called cross links.

In order to realize an installation task—for example, the providing of a voltage distribution between an inverter power supply and consumers—with or without a secured Plus potential—the user assembles several terminal blocks into a terminal block assembly. For example, in order to assemble the afore-mentioned terminal block for the power supply of consumers (hereinafter also called operating means), a feed-in terminal with a housing with relatively large dimensions in the directions normal to the support rail and at least one larger conductor connection arrangement or a conductor connection for conductors of relatively large diameter are placed in a row with several modular terminals suitable for an output function, for example by means of modular through terminals each having a housing of smaller dimensions in these directions and with two or more smaller conductor connection apparatuses for reduced cross-section conductors (compared to the feed-in conductor(s)) of smaller diameter.

The modular terminal blocks of the terminal block assembly, however, generally have sometimes different dimensions. The selection and assembly of the modular terminal blocks—and also the realization of a corresponding circuit with the modular terminal blocks—must be accomplished by the user himself with the aid of catalogs and the like, which can be relatively laborious. Furthermore, on account of the different dimensions of the housings being assembled into a block on the support rail, a relatively unsightly, jagged appearance often results.

A further terminal block and a further modular terminal block arrangement of the prior art is shown by EP 0 222 030 B1. According to this document, several modular terminals of the same dimension are assembled into an initiator terminal block. However, the terminal block is only suitable for the distribution of very small powers. No reduction of the cross section is accomplished.

On the other hand, the present invention takes a different approach, wherein the supply and distribution terminal blocks have the same length and height dimensions, but the width of the supply terminal block is greater than that on the distribution terminal blocks, thereby to permit the contact connections to the relatively-large-diameter supply conductor to be larger than the contact connections to the relatively-small-diameter distribution conductors.

### SUMMARY OF THE INVENTION

Accordingly, a primary object of the invention is to provide a terminal block assembly including a plurality of terminal blocks mounted on a common horizontal support member is provided, including a supply terminal block connected with a voltage source, and a plurality of distribution terminal blocks connected with a plurality of loads, respectively, characterized in that the length and height dimensions of the terminal blocks are the same, but the width of the supply terminal block is greater than that of the distribution terminal blocks, and that the supply conductor contact arrangements of the supply terminal block are designed for connection with a supply conductor having a relatively large cross-sectional area, while the distribution conductor contact arrangements of the distribution terminal blocks are designed for connection with distribution conductors having a relatively small cross-sectional area. A conductive comb member extends transversely across the assembly to interconnect the electrical circuitry contained within the terminal block housings.

According to a more specific object of the invention, the terminal blocks include rectangular housings having coplanar horizontal top walls and contiguous vertical side walls, with the top wall of the supply terminal block containing one or more openings of relatively large size for connection with a relatively large-diameter supply conductor, and the top walls of the distribution terminal block housings containing smaller openings for connection with relatively small-diameter distribution conductors. In one embodiment of the invention, the supply terminal block housing top wall contains two openings for connection with two supply conductors, while in another embodiment, the supply terminal block housing top wall contains a single relatively large supply conductor opening for connection with a single supply conductor, together with a plurality of smaller distribution conductor openings for connection with distribution conductors.

### BRIEF DESCRIPTION OF THE DRAWINGS

Other objects and advantages of the invention will become apparent from a study of the following specification, when viewed in the light of the accompanying drawing, in which:

FIG. 1a is a top plan view of a first embodiment of the terminal block assembly of the present invention;

FIG. 1b is a schematic representation of the electrical circuitry of the apparatus of FIG. 1a;

FIG. 1c is a front perspective view of the apparatus of FIG. 1a;

FIG. 1d is a block diagram of an electrical distribution system using the apparatus of FIG. 1a;

FIG. 1e is a circuit diagram of the Plus voltage distribution portion of the apparatus of FIG. 1;

FIG. 1f is a circuit diagram of the Minus voltage distribution portion of the apparatus of FIG. 1a;

FIG. 1g is a modification of the circuit of FIG. 1f;

FIG. 2a is a top plan view of a second embodiment of the terminal block assembly of the present invention;

FIG. 2b is a schematic representation of the electrical circuitry of the apparatus of FIG. 2a;

FIG. 2c is a front perspective view of the apparatus of FIG. 2a;

FIG. 2d is a block diagram of an electrical distribution system using the apparatus of FIG. 2a;

FIG. 2e is a circuit diagram of the Plus voltage distribution portion of the apparatus of FIG. 2a;

FIG. 2f is a circuit diagram of the Minus voltage distribution portion of the apparatus of FIG. 2a; and

FIG. 2g is a modification of the circuit of FIG. 2f;

### DETAILED DESCRIPTION OF THE INVENTION

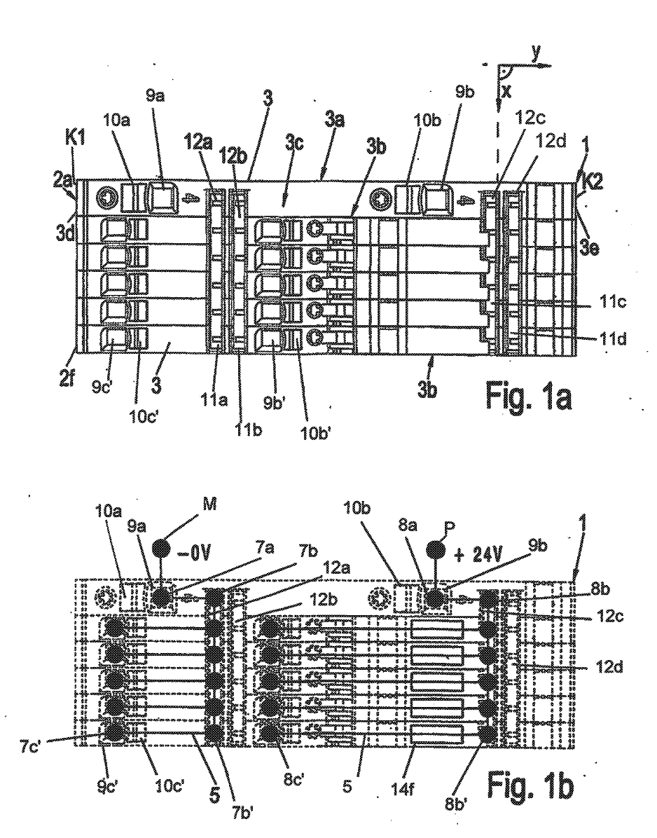

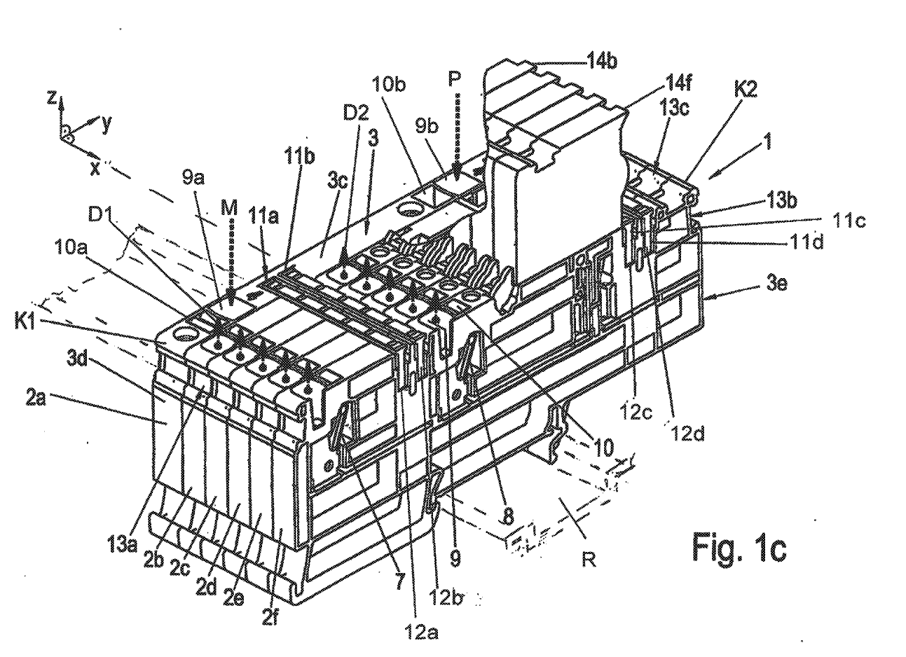

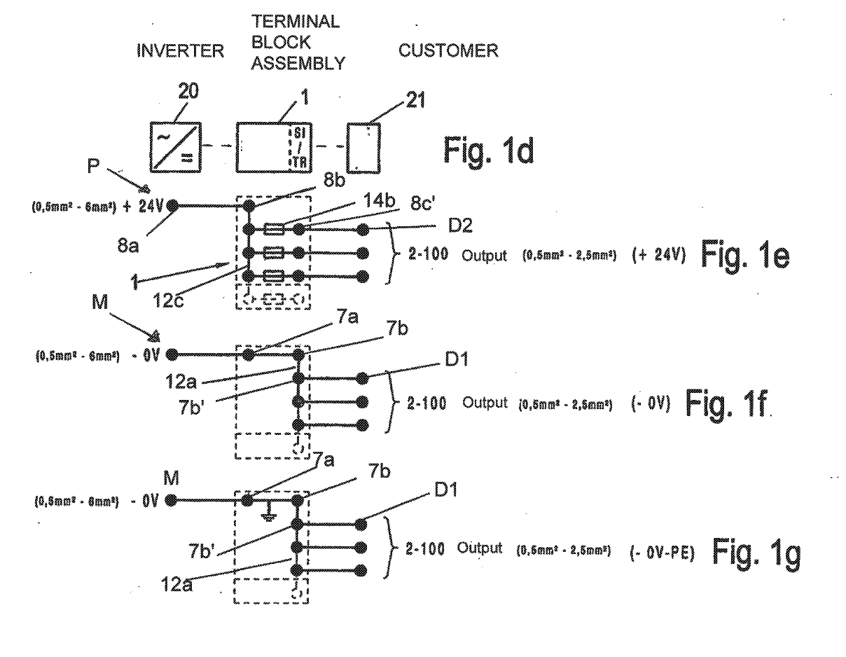

Briefly, referring first more particularly to FIGS. 1a and 1c, the terminal block assembly 1 includes a supply terminal block 2a and a plurality of distribution terminal blocks 2b-2f, mounted in side-to-side relation on a conventional hat-shaped horizontal support rail R. The terminal blocks include rectangular housings 3 having vertical parallel spaced side walls 3a, 3b, a horizontal top wall 3c, and a pair of vertical end walls 3d, 3e. The bottom portion of each terminal block is provided with mounting feet 4 for mounting the terminal blocks on the support rail. In accordance with a characterizing feature of the invention, the height and length dimensions (y and z directions in FIG. 1c) of all of the terminal blocks are the same, but the width of the supply terminal block 2a (x direction in FIG. 1c) is greater than that of the distribution terminal blocks.

Adjacent a first upper corner K1 of the assembly, the top wall 3c of the supply terminal block 2a contains a first relatively large opening 9a for receiving a relatively large-diameter Minus voltage conductor M. Adjacent the other top corner, the supply terminal block top wall contains a second opening 9b for receiving the relatively large-diameter Plus voltage supply conductor P. Push buttons arranged in activation openings 10a and 10b serve to open resilient contacts 7 and 8 arranged below the openings for the insertion and removal of the large-diameter voltage supply conductors.

Similarly, the top walls 3c of the distribution terminal blocks 2b-2f contain openings 9b′ and 9c′ for receiving relatively small-diameter distribution conductors D1 and D2, respectively. Activation openings 10b′ and 10c′ are adapted to receive activating devices—such a push buttons, the tips of screwdrivers, or the like—which open the associated spring contacts 7 and 8 arranged below these openings, respectively, thereby to permit insertion and removal of the distribution conductors.

In order to electrically interconnect the terminal blocks, the top portion of the terminal block assembly contains transverse grooves 11a-11d that receive conductive cross-connecting comb members 12a-12d, respectively. A plurality of fuse devices 14b-14c are mounted on the distribution terminal blocks adjacent the second top corner K2.

As shown by the wiring diagram of FIG. 1b, the relatively large cross-section supply conductor M (that is at a minus [or zero] direct-current potential) is inserted in the opening 9a in the supply terminal block 2a for connection with input contact 7a, which contact is connected by bus bar 5 with the comb contact 7b, which comb contact is connected by conductive comb member 12a to the corresponding comb contacts 7b′ in the distribution blocks 2b-2f. These comb contacts are connected by bus bars 5 with the contacts 7c′ which are connected with the first set of smaller cross-section first distribution conductors D1 (FIG. 1c).

Similarly, the relatively large cross-section positive supply conductor P (having here a potential of +24 volts) is connected with input contact 8a, and then by a bus bar to comb contact 8b. This comb contact is connected by conductive comb member 12c with comb contacts 8b′ of the distribution terminal blocks 2b-2f, which comb contacts are connected with output contacts 8c′ via fuse devices 14b-14f and corresponding bus bars. These output contacts are connected with the second set of smaller-cross-section second distribution conductors D2 (FIG. 1c), respectively, that supply power to the consumers.

More particularly, FIG. 1 shows a first terminal block assembly which consists of at least two or more—here, for example, six—modular terminal blocks 2a-2f arranged in a row in one direction of modular arrangement x. The modular terminal blocks 2a-2f each have a rectangular housing 3 made of an insulator, especially an insulating synthetic plastic material.

One or more or preferably each of the housings 3 of the terminal block assembly 1 has, at its lower side facing a support rail R a fastening foot 4, such as a locking foot, for mounting on the support rail. The housings 3 of the modular terminal blocks 2a-2f of the terminal block assembly each have the same dimensions perpendicular to the direction of modular arrangement (in the directions “y”, i.e., transverse to the direction of modular arrangement x and transverse to the main direction of extension of the support rail, and “z”, i.e., perpendicular to the direction of modular arrangement x and relatively upward to a support rail). Only in the direction of modular arrangement x is the first modular terminal block 2a here broader than the other modular terminal blocks 2b-2f. In the direction of modular arrangement x, the housings 3 have their (largest) main sides 3a, 3b arranged in a row (except for the very outside in the block). In the z-direction or parallel to the x/z-plane, they have narrow sides 3d, 3e. The narrow sides 3d, 3e border on the top side 3c of the housing 3 in two corner regions K1 and K2.

Preferably, the modular terminal blocks 2a, 2b, 2c, . . . of the terminal block assembly 1 are joined together, for example, by corresponding clamping or locking pins (not seen here) on their outer sides adjoining each other and extending perpendicular to the direction of modular arrangement.

In the interior of the housing 3 of each modular terminal 2a-2f there is provided at least one or (here) preferably two conductor connection arrangements 7, 8 (see the modular terminal block 2f in FIG. 1c) for the connection of electrical conductors. Preferably, the conductor connection arrangements 7, 8 are designed as so-called push-in spring terminals with a compression spring connection, which has a compression spring that serves to press the inserted conductor in conducting manner against a current bus bar (not seen here). The use of push-in spring terminals is especially preferred, since their handling is especially simple, secure, and rapid. But other conductor connection apparatuses such as tension spring connections, IDC connections, or screw connections can also be used.

For each of the conductor connection apparatuses 7, 8 there is a conductor insert opening 9 and preferably also an activation opening 10 formed in the housing, where each bare end stripped of insulation of the conductor or the like can be introduced through the conductor insert openings 9 into a contact region, especially a clamping contact region, in the corresponding conductor connection apparatus 7, 8. The optional activation opening 10, on the other hand, serves to accommodate an operating element—such as a push button arranged in the housing and activated by a screw driver, or the tip of a screw driver—in the housing in order to open the spring or the conductor connection apparatus, so that an inserted conductor can be removed once more or be inserted.

All of the conductor insert openings 9 and the optionally present activation openings 10 are formed on the narrow top side 3c—i.e., on the side of the housing 3 of the modular terminal block 2 facing away from the fastening foot 4. This makes the terminal block 1 especially clearly laid out and its handling especially simple—especially the wiring with conductors and the connecting to form an upper-level system.

More particularly, each of the conductor connection arrangements 7-8 (in FIG. 1b represented as a dark spot and in FIG. 1c indicated by arrow) is moreover led across a conductor connection, such as a bus bar 5 (not recognizable here but indicated schematically in FIG. 1b) inside the housing (or another suitable conductor) into or beneath the region of at least one cross connection link channel 11 in the housing 3. Here, two cross connection link channels 11a, 11b are provided for each conductor connection apparatus 3.

The cross connection link channel(s) 11a, 11b serve each time for the inserting of a cross-connection link conductive comb member 12a, 12b, for the distribution of a potential in the direction of modular arrangement x of the terminal block 1 across two or more of the modular terminal blocks 2a-2f. For this, the respective current bus bars can be provided with holes in the corresponding regions beneath or at the bottom of the cross connection link channels 11a, b, in which pins or fingers of the cross connection link comb can be inserted (not evident here). Preferably and advantageously, two of the cross connection link combs 12a, 12b are provided for each conductor connection apparatus and current bus bar in order to cross distribute a corresponding potential “+” or “−” or “P” or “M” each time.

Thus, on the whole, each of the modular terminal blocks 2a-2f preferably has four cross connection link channels 11a-11d and optionally four pluggable and preferably also plugged-in cross links, especially cross connection link combs 12a-12d. On the two narrow end walls 3d, 3e of the housing 3 extending in the y direction perpendicular to the longitudinal direction x—here, as far as the upper edge—there are advantageously provided contours 13a, 13b in the upper region for the placement of markers (not shown here), preferably by snapping on.

The first modular terminal block 2a of the terminal block assembly 1 for the power distribution according to FIG. 1e is designed as an input terminal block. The housing 3 of this first modular terminal block 2a has a greater width in the direction of modular arrangement than the other housings 3. This first modular terminal 2a forms, preferably at one side, the exposed end of the terminal block assembly, which makes the terminal block assembly 1 clean in its layout. But it would also be conceivable to arrange this feed-in terminal block 2a in another place in the terminal block assembly 1. Preferably, the free outer side 3a of the first modular supply terminal block 2a or feed-in terminal is closed and facing away from the next adjacent modular terminal block 2b.

On the side facing away from the fastening foot, each housing 3 has two of the conductor insert openings 9. One of the conductor insert openings 9 is arranged relative to one edge K1 on the top side 3c of the respective modular terminal and the other of the conductor insert openings is arranged on the top side 3c, starting from this edge K1 on the section between K1 and K2 in a region between around 60 and 90% of the length of the section between K1 and K2.

Starting from the edge K1, there are formed on the top side, here behind the first and the second conductor insert opening 9, preferably every one or preferably every two of the cross connection link channels 11a, 11b, which in turn end preferably at the middle of the first modular terminal block 2a, configured as a feed-in terminal, in the direction of modular arrangement x in the housing 3, which is preferable but not mandatory.

The other terminal blocks 2b-2f lined up next to the feed-in terminal 2a have a somewhat different construction. These other modular terminal blocks 2b-2f serve for the connecting of preferably one of the consumers to each of the other modular terminals 2b-2f, also known as distribution board terminals.

The top sides 3c of these distribution board terminals 2b-2f have the following construction. Each time adjacent to one edge K1 is the conductor insert opening 9 of the first conductor connection apparatus, then the activation opening 10, preferably with push button, and then the one or the two or more of the cross connection link channels 11a, 11b associated with the first conductor connection apparatus, in which a cross-connection link comb 12a, b can be inserted in turn.

Then there follows, in the direction of the second edge K2, at first the insert opening 9 of the second conductor connection apparatus, then its activation opening 10, preferably with a push button, then a fuse housing 14b-14f with fuse and plug-in contacts for making contact with a bus bar in the housing 3, and then the cross connection link channel(s) 11a, 11b of the second conductor connection apparatuses. Between the second cross connection link channels 11a, 11b and the second edge K2 there is then preferably arranged yet another contour 13c for the placement of a third marker.

The first conductor connection arrangement and the first conductor connection of the feed-in terminal block 2a lies roughly flush with the other first conductor connection apparatuses or conductor connection apparatuses 7 of the lined-up distribution board or output terminal blocks 2b-2f.

The second conductor connection arrangements of the modular terminal blocks 2b-2f (which can also be called distribution board or output terminals 2b-2f) serve preferably to connect conductors with at most a somewhat smaller cross section than is allowed by the first conductor connection arrangements of the feed-in terminal block 2a. Thus, there is a reduction in the cross-section of the conductor from the feed-in terminal 2a to the distribution board terminal blocks 2b-2f. The cross connection link channels 11 and the cross connection link combs 12 for the cross distribution of the first potential (preferably “Plus”; this potential is distributed in the representation of FIG. 1c in the left region of the terminal or to the edge K1) lie at the side of these first conductor connection apparatuses and are conductively connected to them.

In this way, the functional region for the feeding in and the cross-distributing and realizing of the first potential (Minus) of the output connections takes up less than half, preferably around a third, of the top side 3c of the housing 3 of the modular terminals 2. The rest, preferably the remaining two thirds of the top side 3c of the housing 3 of the modular terminal assembly serves for arranging the other conductor insert openings 9 for the conductor connection apparatuses for the connecting of conductors to relay the Plus potential, for the placement of the respective fuse housing 14b-14f, for the arranging of one or two additional cross-connection link channels 11 for cross links comb members 12 and for the forming of the additional mounting contour 13c for the placement of a third marker.

In this way, the second potential (Plus) is cross-distributed from the feed-in terminal 2a, distributed across current bus bars and plug-in devices into the fuse housing with the fuses, and from here across the fuses and contacts on the fuse housing 14 back to bus bar pieces which are connected to the second conductor connection apparatuses of the modular terminal blocks 2b-2f lined up next to the feed-in terminal. In this way, a fuse is hooked up each time between the input for the feeding of the second potential and the further outputs (conductor connection contacts 8).

The terminal block assembly 1 of FIG. 1c thus, with only a few modular terminals, realizes preferably the function “(auxiliary) power distribution with single fuse of FIG. 1e. The feeding of the Plus (+24 volt) and Minus (−0 volt) potentials at the feed-in terminal block 2a is done with a larger cross section, which is preferably from 0.5 mm² up to 6 mm² (which is generally enough for a 40 ampere power supply in terms of current). This becomes possible for only a few modular terminals, since the arrangement of the functional regions on the top sides of the modular terminals is clearly laid out and in particular optimized in terms of function.

Thus, with the terminal block assembly of FIG. 1c, the auxiliary power distribution with a protection of the Plus potential by a fuse is realized in especially simple and clearly laid out manner. The Plus and Minus potentials are fed in at the feed-in terminal block 2a and relayed each time with reduction in cross section at the individual distribution board terminal blocks 2b-2f to the operating means or consumers (see FIG. 1a-1e). The Plus potential has a single fuse protection at the output side. The Minus potential is fed in, reduced in cross section, and relayed directly to the individual operating means. Alternatively, it can also be connected to the support rail across a PE foot or be grounded, which can be used as a functional ground or as a PE potential. The distribution conductors have a cross-section of from about 0.5 mm² to about 2.5 mm².

It is advantageous that two potentials are distributed in simple and especially clearly laid out manner for each distribution board terminal with integrated fuse function. This results in a design with only a few terminals as compared to the known design, in which the potential carried across a fuse is distributed across one terminal and the other respective potential across another terminal.

It is also advantageous that the outputs or conductor connection apparatuses of the distribution board terminals lie on the top side 3c with the fuse housing 14 placed thereon, since this makes the circuitry or the connection situation especially logical and clearly visible on the respective housing 3. The number of distribution board terminal blocks 2b-2e here is only an example. It is also possible to provide for each feed-in terminal block only one or also several of the many more (preferably up to 100) distribution terminal blocks.

FIGS. 1f and 1g show circuits for an analogous auxiliary power supply distribution, yet in which the Plus potential is not protected by a single fuse. Therefore, the second conductor connection apparatuses of the distribution board terminals can be directly connected here to their cross-connection link channels without a fuse being included in the conductor pathway. Thus, this function can also be realized with a terminal block according to FIG. 1c but one without a fuse housing and fuse and with a continuous bus bar in this region (not represented).

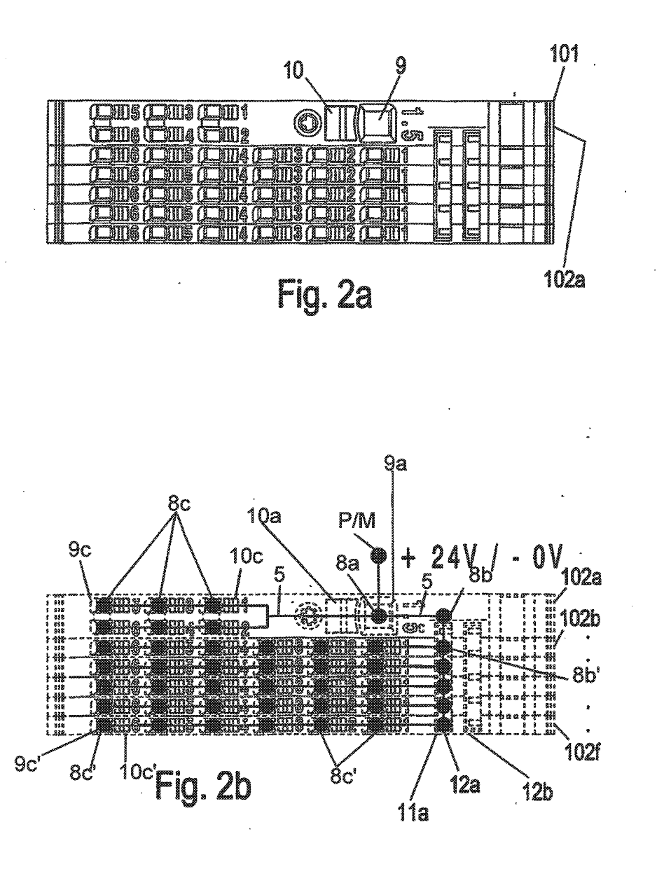

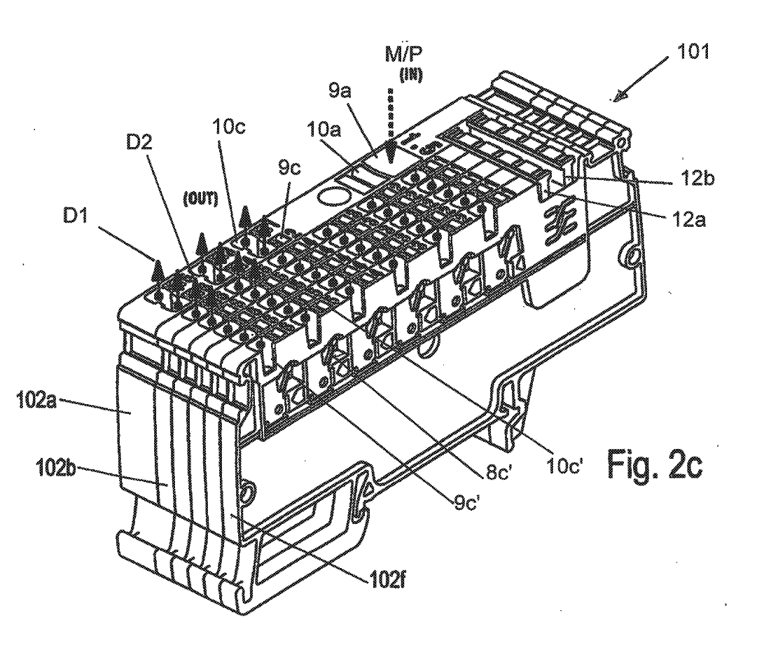

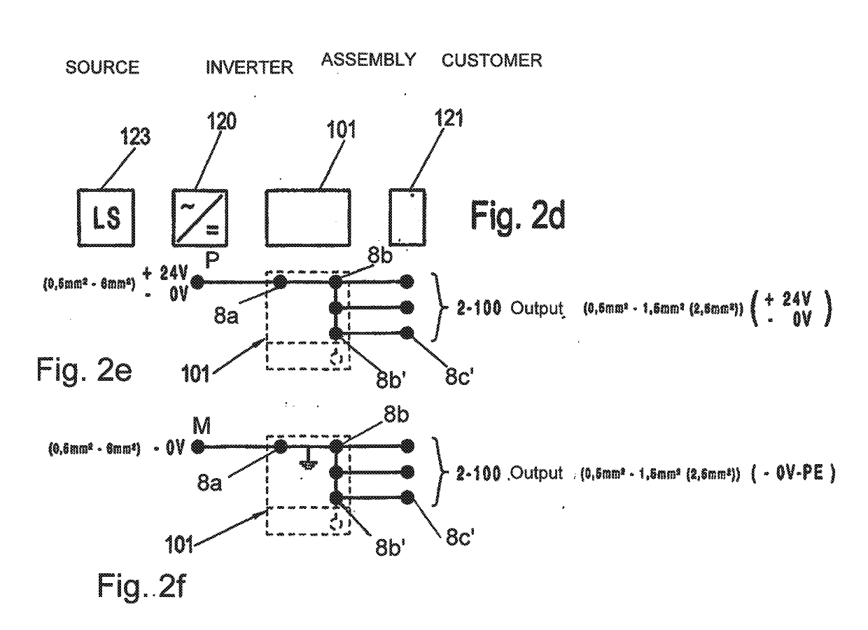

In one or in each of the modular terminals of the terminal block in FIG. 1c (or also FIG. 2c, as will be explained below), the Minus potential can be connected conductively to the support rail across a conductive contact at the foot of the support rail, in order to connect the Minus potential to a ground potential, such as a functional ground FE or to a potential PE.

It should further be noted that, in the terminal block assembly 1 in FIG. 1c (and also the terminal block assembly 101 in FIG. 2c), all the conductor insert openings 9 and their corresponding activation openings 10 in the feed-in terminal and reaching through into the distribution board terminals 2b-2f are arranged each time in the same direction or relative to one of the corners K1 for each of the conductor connection apparatuses in the same series (in the y-direction), which helps make the overall terminal block assembly 1 especially cleanly laid out. Thus, in the feed-in terminal block 2a, the activation openings 10 with push buttons lie relative to the corner K1 on the side of the conductor insert openings 9 facing this corner K1, while the opposite is the case in the distribution board terminal blocks 2b-2f. On the other hand, if standard through terminals are used for the distribution, the conductor insert openings there are arranged generally on both sides of a mid-plane perpendicular to the middle of the support rail (x/y plane) in opposite directions. But it is more clear and logical to select a same-direction arrangement for the same function (i.e., input potential, distributing potential).

FIG. 2 shows another terminal block assembly 101, which is used for auxiliary power supply distribution without fuse protection. It should be noted that here as well all conductor insert openings 9 and their corresponding activation openings 10 preferably with push buttons for the distribution (output) are arranged in the same direction in the same series with regard to one of the corners K1 of the housing 103 on the top sides 103c (in the y-direction transverse to the direction of modular arrangement x), which helps make the overall terminal block assembly 1 especially cleanly laid out. Only the conductor insert opening 9a and the activation opening 10a with push button for feed-in (indicated in FIG. 2c by an arrow pointing into the housing 103) are somewhat rearranged in order to illustrate the functional difference (feeding in, distributing).

Advantageously, only a single potential is distributed for each terminal block assembly 101. Therefore, in order to hook up or distribute Plus and Minus voltage power to consumers, two modular terminal blocks of the same or largely the same design are needed (FIGS. 2d, 2e).

Briefly, as shown in FIGS. 2b and 2c, the input large-diameter supply conductor—P (+24 volt) or M (−0 volt)—supplies power to input contact 8a of the supply terminal block 102a, which contact is connected by bus bar 5 with six small-diameter distributor contact arrangements 8c, 9c, 10c that are connected with a first set of small-diameter distribution conductors D1 (FIG. 2c), respectively, that supply power to the consumers . This input contact 8a is also connected by a bus bar 5 with contact 8b that is connected by conductive comb member 12a with corresponding contacts 8b′ on a plurality of distribution terminal blocks 102b-102f. These contacts 8b′ are connected by bus bars 5 with small-diameter contact arrangements 8c′, 9c′, 10c′ that are connected with a second set of small-diameter distribution conductors D2 (FIG. 2c) that also distribute power to the consumers.

More particularly, a supply terminal block 102a once again serves to apply or feed in the potential. This has a first conductor connection of larger cross section 8a, 9a, 10a, which serves to connect the potential P/M being fed in or distributed. For this, the first conductor connection is designed for the connecting of conductors of larger cross section (such as 0.5 mm² to 6 mm²). Already with the first modular terminal or this feed-in terminal block, the potential is taken with cross-section reduction to several second conductor connection arrangements (outputs). The first conductor connection here is arranged along with two cross-connection link channels 11a in a first half of the top side 3c, while the second conductor connection apparatuses or their conductor insert openings 10 are distributed in the second half of the top side 3c of the supply terminal block 102a. In the supply terminal block 102a, there are provided in the one half of the top side 3c two rows of one, two, or preferably three or even more of the second conductor insert openings or conductor connection apparatuses, so that already in the feed-in terminal 102a six distributor conductor connection arrangements D1 are also formed as outputs along with their openings 9 and 10 on or in the top side 3c. Thus, from the pure supply terminal block, a combined supply and distribution board terminal block 102a is produced.

On the housing 3 at the top side of each modular terminal block 102a-102f of the terminal block assembly 101, once again one or two or more of the cross connection link channels 11a, 11b are formed. The other modular terminals 102b-102f are configured as pure distribution board terminal blocks. Finally, the contours 13a-13c of the housing 3 correspond to those of the housing of FIG. 1. That is, wherein a contour 13c is also formed for the placement of a marker between the cross connection link channels 12a, 12b and the corner K2.

By means of the one or by means of two or more cross connection link combs 12a-12b, the supply potential is cross distributed from the supply/distribution terminal block 102a to the distribution terminal blocks 102b-102f. By the cross connection link combs 12, each time the potential is distributed across a conductor, such as a bus bar in the housing 3, to at least one row of second conductor connection arrangements 8. For example and advantageously, six output conductor connection arrangements 8 are provided here for each distribution board terminal block 2b-2f. In this way, a potential is distributed to many tapping points in a narrow space, whereby each of the modular terminal blocks of the terminal block assembly 101, including the feed-in terminal block 102a, is used also or only as an output terminal block and a distribution board terminal block. Here, again, the number of distribution board terminal blocks in the row is merely an example. There could easily be 100 or even more outputs provided.

In regard to the function of a power supply distribution which is realized, it should be noted that the potential is fed in at the feed-in terminal 102a (feed-in terminal 2a), the cross section is then reduced inside the feed-in and distribution board terminal 102a, and it is then relayed in another segment of the feed-in terminal or in another distribution board terminal to conductor connection apparatuses of smaller cross section.

The Plus potential (+24 volts) can be distributed in one such terminal block assembly 101, the Minus potential in another terminal block assembly (optionally of different color or provided with push buttons of different color in the activation openings 10), which in turn can optionally be grounded with a contact foot on the support rail.

While in accordance with the provisions of the Patent Statutes the preferred forms and embodiments of the invention have been illustrated and described, it will be apparent to those skilled in the art that changes may be made without deviating from the invention described above.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A terminal block assembly (1; 101), comprising:
(a) a plurality of terminal blocks (2a-2f; 102a-102f) mounted in side-by-side relation on a common horizontal fixed support (R):
(1) each of said terminal blocks having a rectangular housing (3) containing electrical circuitry and including a pair of parallel vertical side walls (3a, 3b), a horizontal top wall (3c), and a pair of vertical end walls (3d, 3e);
(2) at least one of said terminal blocks comprising a supply terminal block (2a; 102a) adapted for connection with a voltage source (20; 120);
(3) each of the remaining terminal blocks (2b-2f; 102b-102f) comprising a distribution terminal block adapted for connection with a load (21; 121); and
(4) at least one electrically-conducting link comb (12) extending transversely across said terminal blocks to interconnect the electrical circuits contained therein;
(b) each of said terminal blocks having the same dimensions in directions (y and z) orthogonally arranged relative to the axis (x) defined by the support member;
(c) said supply terminal block having supply contact connections (8a, 9a, 10a) designed for connection with supply conductors (M/P) having a relatively large cross-sectional area;
(d) said distribution terminal blocks having distribution contact connections (7b, 8b, 9b, 10b) designed for connection with distribution conductors (L1, L2) having a relatively small cross-sectional area.

20. A terminal block assembly as defined in claim 19, wherein each of said terminal block housings includes on its lower portion a foot arrangement (4) for removably mounting said housing on said fixed support.

21. A terminal block assembly as defined in claim 20, wherein each of said supply and distribution contact connections comprises a resilient electrical contact (7, 8) arranged beneath a housing opening (9) contained in said housing top wall, and an actuation arrangement (10) for opening said contact to receive a conductor that is inserted into said opening and is clamped to said housing upon release of said contact.

22. A terminal block assembly as defined in claim 21, and further including at least one bus bar (5) arranged within said housing and connected with said resilient contact, thereby to connect the conductor with electrical circuitry contained in said housing.

23. A terminal block assembly as defined in claim 22, and further including:
(e) a cross-link conductive comb member (12) extending transversely across said terminal blocks for electrically connecting the electrical circuitry contained in selected ones of said terminal blocks.

24. A terminal block assembly as defined in claim 19, wherein at least some of said housing end walls contains deformations (13b) for receiving indicia-bearing markers.

25. A terminal block assembly as defined in claim 24, wherein one of said deformations (13c) is adjacent one corner (K2) between said housing top and side walls.

26. A terminal block assembly as defined in claim 19, wherein one of said terminal blocks comprises a supply terminal block (2a; 102a) having a greater width than that of each of said distribution terminal blocks.

27. A terminal block assembly as defined in claim 26, wherein the top wall (3c′) of said supply terminal block contains a first conductor opening (9a) adjacent a first top corner (K1) of said supply terminal block housing, and a second conductor opening (9b) spaced from said first top corner about 60% to 90% of the distance of the length of said supply terminal block housing.

28. A terminal block assembly as defined in claim 27, wherein the top portion of said terminal block assembly contains a plurality of cross-connecting grooves (11a-11d) that extend transversely across the top portions of all of said terminal blocks.

29. A terminal block assembly as defined in claim 28, and further including a plurality of conductive comb members (12a-12d) arranged in said cross-connecting grooves for electrically connecting together the contacts (8a, 8a′, 8c, 8c′) of electrical circuitry contained in said terminal block housings, respectively.

30. A terminal block assembly as defined in claim 29, wherein said distribution terminal blocks include two parallel spaced rows of output contacts (7a′, 8b′) connected with the electrical circuitry of said distribution terminal blocks, respectively, said outlet contacts being connected with load conductors (L1, L2) having relatively smaller cross-sectional areas via corresponding outlet conductor openings (9a′, 9b′) contained in the housing top walls.

31. A terminal block assembly as defined in claim 30, wherein a first row of said outlet contacts (7a′) is connected with a first voltage source (M) via a first transverse conductive comb member (12a), and a second row of said outlet contacts (8b′) is connected with a second voltage source (P) via a second transverse conductive comb member (12c).

32. A terminal block assembly as defined in claim 31, wherein said terminal block assembly includes a plurality of fuse devices (14b-14f) mounted on said distribution terminal block housing top walls, respectively, each of said fuse devices being connected in the electrical circuitry between said second comb member (12c) and said second row of output contacts (8b′), respectively.

33. A terminal block assembly as defined in claim 31, wherein said first row of outlet contacts (8a′) is connected with ground via said support member.

34. A terminal block assembly as defined in claim 19, wherein:
(e) said supply terminal block (102a) also includes distribution contact connections (8c′, 9b′, 10b′) designed for connection with distribution conductors (L1) having a relatively small cross-sectional area.

35. A terminal block assembly as defined in claim 34, and further including a comb member (12a) for connecting a supply contact (8b) of said supply terminal block with corresponding contacts (8b′) of each of said distribution terminal blocks.

36. A terminal block assembly as defined in claim 35, wherein said supply terminal block supply contact is connected with ground.

37. A terminal block assembly as defined in claim 19, wherein the cross-sectional area of the supply conductor is from about 0.5 mm² to about 6 mm², and the cross-sectional area of the distribution conductor is from about 0.5 mm² to about 2.6 mm².
